(19) United States
(12) Patent Application Publication
(10) Pub. No.: US 2006/0085464 A1
(43) Pub. Date: Apr. 20, 2006

(54) Method and system for providing referential integrity constraints

(75) Inventors: Daniel E. Beuch, Rochester, MN (US); John Matthew Santosuosso, Rochester, MN (US)

Correspondence Address: WOOD, HERRON & EVANS, L.L.P., 2700 CAREW TOWER, 441 VINE STREET, CINCINNATI, OH, 45202, US

(73) Assignee: INTERNATIONAL BUSINESS MACHINES CORPORATION, ARMONK, NY (US)

(21) Appl. No.: 10/965,124

(22) Filed: Oct. 14, 2004

(51) Int. Cl. G06F 7/00

(52) U.S. Cl. 707/101

(57) ABSTRACT

A master table and one or more slave tables are linked together by different referential integrity constraints. A database engine maintains a separate data structure that includes information about which slave tables include corresponding records that may be affected by a constraint. Accordingly, when an operation is performed on the master table, the data structure is referenced to determine which slave tables has records which are affected as well. The data structure may be a bitmap, an encoded vector index, or separate fields within the master database. As a result of this data structure, unnecessary I/O operations are avoided involving slave tables without a corresponding record.

### FIELD OF THE INVENTION

The invention relates to database management systems, and in particular, to improving database performance.

### BACKGROUND OF THE INVENTION

Databases are used to store information for an innumerable number of applications, including various commercial, industrial, technical, scientific and educational applications. As the reliance on information increases, both the volume of information stored in most databases, as well as the number of users wishing to access that information, likewise increases. Moreover, as the volume of information in a database, and the number of users wishing to access the database, increases, the amount of computing resources required to manage such a database increases as well.

Database management systems (DBMS's), which are the computer programs that are used to access the information stored in databases, therefore often require tremendous resources to handle the heavy workloads placed on such systems. As such, significant resources have been devoted to increasing the performance of database management systems with respect to processing searches, or queries, to databases.

Improvements to both computer hardware and software have improved the capacities of conventional database management systems. For example, in the hardware realm, increases in microprocessor performance, coupled with improved memory management systems, have improved the number of queries that a particular microprocessor can perform in a given unit of time. Furthermore, the use of multiple microprocessors and/or multiple networked computers has further increased the capacities of many database management systems.

From a software standpoint, the use of relational databases, which organize information into formally-defined tables consisting of rows and columns, and which are typically accessed using a standardized language such as Structured Query Language (SQL), has substantially improved processing efficiency, as well as substantially simplified the creation, organization, and extension of information within a database. Furthermore, significant development efforts have been directed toward query “optimization”, whereby the execution of particular searches, or queries, is optimized in an automated manner to minimize the amount of resources required to execute each query.

Through the incorporation of various hardware and software improvements, many high performance database management systems are able to handle hundreds or even thousands of queries each second, even on databases containing millions or billions of records. However, further increases in information volume and workload are inevitable, so continued advancements in database management systems are still required.

Even though current query optimizers are robust enough to routinely select the best access plan for execution, there are still instances in which query performance is below user expectations and other techniques are needed to improve performance of a database. One area that affects execution performance is I/O operations. Reducing the number of I/O operations performed during a query will, in many cases, significantly improve the performance of that query. The number of I/O operations performed by a single query may be larger than expected in many cases because of constraints imposed between a master database table and dependent, or slave, tables. Such constraints are often used to ensure that when a record in the master table is acted upon, then appropriate records in the slave tables are acted upon as well.

Referential constraints are typically used to ensure that data values among the tables in a database meet certain business rules. For example, in a “Purchase Order” table, a record should not be allowed to exist that references a customer number that does not exist in a master “Customer” table. Thus, at a table-to-table level certain referential constraints or rules are defined. One rule might be that, if a particular customer, for example, is deleted from the “Customer” table, then all records in the slave tables referencing that customer number should be deleted as well. As a result, performing an action on a record in the master table results in all related tables having defined constraints being read into memory and searched for records that need to be changed as well. This results in a large number of I/O operations, some of which are unnecessary.

Thus, there remains the need in prior database environments for a system that reduces I/O operations when performing database queries and, more particularly, in situations where referential integrity constraints contribute to excessive I/O operations.

### SUMMARY OF THE INVENTION

One particular aspect of the present invention relates to a method for providing a referential integrity constraint among a plurality of related tables comprising a master table and one or more slave tables. In accordance with this aspect of the invention, an action involving a record of the master table is identified. Such actions can include instructions such as INSERT or DELETE. Based on the action, it is determined which of the slave tables include at least one record related to the action. The determination is performed using data that is separate from the slave tables themselves.

Another aspect of the present invention relates to a database. This database includes a master table and a slave table linked to the master table through a constraint. In accordance with this aspect of the invention, the database also includes a data structure storing referential integrity constraint information related to the constraint between records of the master table and the slave table. Thus, the data structure can be used to determine if the slave table includes a record corresponding to a particular record of the master table without having to actually open the slave table and search for corresponding records.

Thus, embodiments of the present invention relate to a database system in which a master table and one or more slave tables are linked together by different referential integrity constraints. A database engine maintains a separate data structure that includes information about which slave tables include corresponding records that may be affected by a constraint. Accordingly, when an operation is performed on the master table, the data structure is referenced to determine which slave tables have records that are affected as well. In particular embodiments, the data structure may be a bitmap scheme, an encoded vector index, or separate fields within the master database. As a result of this data structure, unnecessary I/O operations are avoided involving slave tables without a corresponding record.

### BRIEF DESCRIPTION OF THE DRAWINGS

FIG. 1 is a block diagram of a networked computer system incorporating a database management system consistent with the invention.

FIG. 2 is a block diagram illustrating the principal components and flow of information therebetween in the database management system of FIG. 1.

FIG. 3 illustrates a flowchart of an exemplary method for checking referential integrity constraints of slave tables while reducing I/O operations in accordance with the principles of the present invention.

### DETAILED DESCRIPTION

As mentioned above, the embodiments discussed hereinafter utilize a database engine and data structures that support identifying slave tables that have records needing to be acted upon due to referential integrity constraints. Instead of reading each related slave table and searching for related records, the data structure provides this information in a compact and easy to use format. A specific implementation of such a database engine and monitoring tool capable of supporting this functionality in a manner consistent with the invention will be discussed in greater detail below. However, prior to a discussion of such a specific implementation, a brief discussion will be provided regarding an exemplary hardware and software environment within which such an implementation may reside.

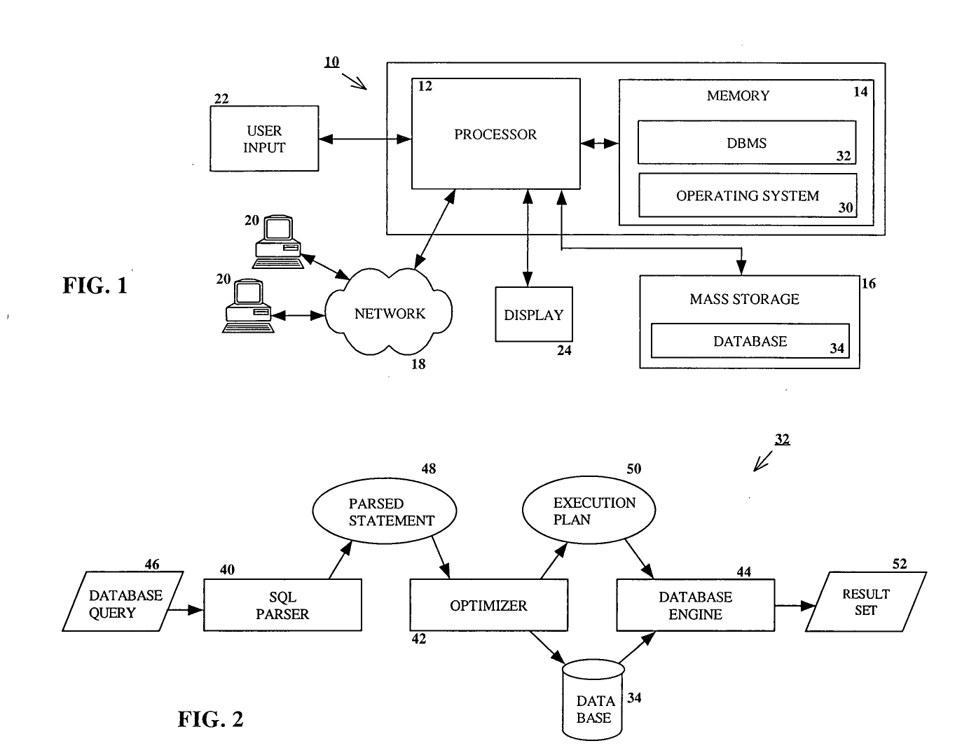

Turning now to the Drawings, wherein like numbers denote like parts throughout the several views, FIG. 1 illustrates an exemplary hardware and software environment for an apparatus 10 suitable for implementing a database management system that satisfies referential integrity constraints between database tables consistent with the invention. For the purposes of the invention, apparatus 10 may represent practically any type of computer, computer system or other programmable electronic device, including a client computer, a server computer, a portable computer, a handheld computer, an embedded controller, etc. Moreover, apparatus 10 may be implemented using one or more networked computers, e.g., in a cluster or other distributed computing system. Apparatus 10 will hereinafter also be referred to as a “computer”, although it should be appreciated the term “apparatus” may also include other suitable programmable electronic devices consistent with the invention.

Computer 10 typically includes at least one processor 12 coupled to a memory 14. Processor 12 may represent one or more processors (e.g., microprocessors), and memory 14 may represent the random access memory (RAM) devices comprising the main storage of computer 10, as well as any supplemental levels of memory, e.g., cache memories, non-volatile or backup memories (e.g., programmable or flash memories), read-only memories, etc. In addition, memory 14 may be considered to include memory storage physically located elsewhere in computer 10, e.g., any cache memory in a processor 12, as well as any storage capacity used as a virtual memory, e.g., as stored on a mass storage device 16 or on another computer coupled to computer 10 via network 18 (e.g., a client computer 20).

Computer 10 also typically receives a number of inputs and outputs for communicating information externally. For interface with a user or operator, computer 10 typically includes one or more user input devices 22 (e.g., a keyboard, a mouse, a trackball, a joystick, a touchpad, and/or a microphone, among others) and a display 24 (e.g., a CRT monitor, an LCD display panel, and/or a speaker, among others). Otherwise, user input may be received via another computer (e.g., a computer 20) interfaced with computer 10 over network 18, or via a dedicated workstation interface or the like.

For additional storage, computer 10 may also include one or more mass storage devices 16, e.g., a floppy or other removable disk drive, a hard disk drive, a direct access storage device (DASD), an optical drive (e.g., a CD drive, a DVD drive, etc.), and/or a tape drive, among others. Furthermore, computer 10 may include an interface with one or more networks 18 (e.g., a LAN, a WAN, a wireless network, and/or the Internet, among others) to permit the communication of information with other computers coupled to the network. It should be appreciated that computer 10 typically includes suitable analog and/or digital interfaces between processor 12 and each of components 14, 16, 18, 22 and 24 as is well known in the art.

Computer 10 operates under the control of an operating system 30, and executes or otherwise relies upon various computer software applications, components, programs, objects, modules, data structures, etc. (e.g., database management system 32 and database 34, among others). Moreover, various applications, components, programs, objects, modules, etc. may also execute on one or more processors in another computer coupled to computer 10 via a network 18, e.g., in a distributed or client-server computing environment, whereby the processing required to implement the functions of a computer program may be allocated to multiple computers over a network.

Turning briefly to FIG. 2, an exemplary implementation of database management system 32 is shown. The principal components of database management system 32 that are relevant to query optimization are an SQL parser 40, cost-based optimizer 42 and database engine 44. SQL parser 40 receives from a user a database query 46, which in the illustrated embodiment, is provided in the form of an SQL statement. SQL parser 40 then generates a parsed statement 48 therefrom, which is passed to optimizer 42 for query Optimization. As a result of query optimization, an execution or access plan 50 is generated, often using data such as platform capabilities, query content information, etc., that is stored in database 34. Once generated, the execution plan is forwarded to database engine 44 for execution of the database query on the information in database 34. The result of the execution of the database query is typically stored in a result set, as represented at block 52.

Other components may be incorporated into system 32, as may other suitable database management architectures. Other database programming and organizational architectures may also be used consistent with the invention. Therefore, the invention is not limited to the particular implementation discussed herein.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable signal bearing media used to actually carry out the distribution. Examples of computer readable signal bearing media include but are not limited to recordable type media such as volatile and non-volatile memory devices, floppy and other removable disks, hard disk drives, magnetic tape, optical disks (e.g., CD-ROM's, DVD's, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Those skilled in the art will recognize that the exemplary environment illustrated in FIGS. 1 and 2 is not intended to limit the present invention. Indeed, those skilled in the art will recognize that other alternative hardware and/or software environments may be used without departing from the scope of the invention.

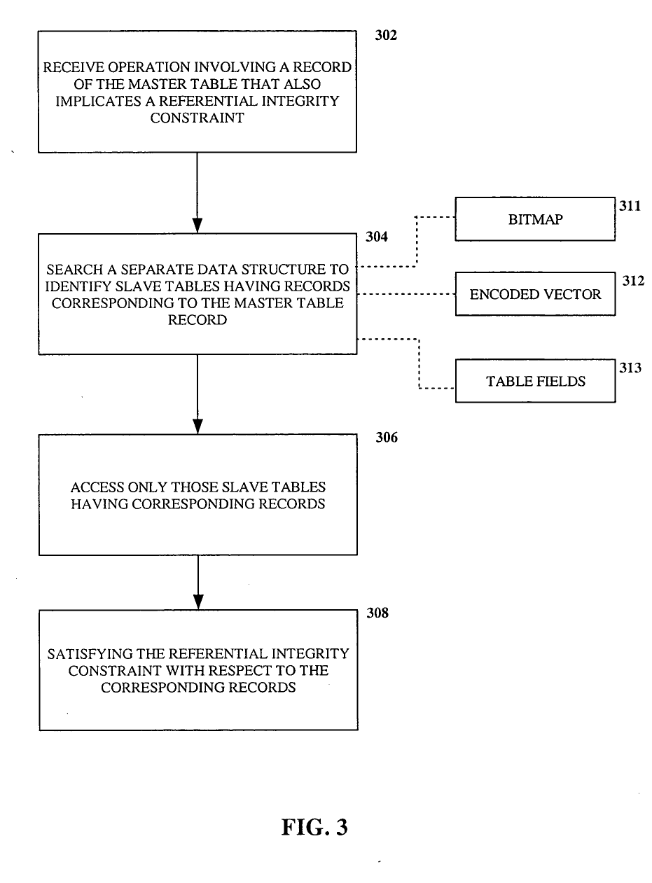

Turning now to FIG. 3, a flowchart is depicted of an exemplary method of satisfying referential integrity constraints between database tables in accordance with the principles of the present invention. FIG. 3 is described below within the context of a CASCADING DELETE operation within a series of database tables. This type of operation is exemplary in nature and other operations on a master table may just as easily implicate records in other database tables. Thus, one of ordinary skill will recognize that there are many types of referential constraints possible between tables of a database and the principles of the present invention are equally applicable to these type of constraints as they are to the exemplary DELETE constraint described in detail.

Business rules often create referential integrity constraints between a master table of a database and multiple slave tables. For example, consider a database having a list of customers in one table and a list of accounts in another table. It would not make business sense to allow an INSERT in the accounts table for an associated customer that does not exist in the customer table. Likewise, it does not make business sense to delete a customer from the customer table until all of their accounts are deleted from the accounts table. One particular constraint known as a CASCADING DELETE can be used to automatically delete records from all slave tables based on a record being deleted from the master table. The CASCADING DELETE utilizes links that are defined between tables when they are created. Thus, the database engine when receiving an instruction to DELETE a customer, for example, will automatically generate a number of DELETE operations that are performed on every table linked, directly or indirectly, to the master table.

In many real-world scenarios multiple files are linked to multiple files and a CASCADING DELETE will result in referencing a number of tables that do not even have a record that corresponds to the record being deleting from the master table. One problem with this situation is that each linked table must be opened and searched to determine if a record exists that must be DELETED. This adds a significant number of I/O operations, some of which are unnecessary.

According to FIG. 3, a database operation is received, in step 302, that indicates performing an action on a record of the master table. In response to this action, a referential integrity constraint is identified that must be followed. Not all actions on the master table necessarily involve a referential integrity constraint, but, for purposes of explanation, the particular action of step 302 does involve such a constraint.

Instead of blindly searching through all the linked tables involved in this referential integrity constraint, the database engine, in step 304, searches a separate data structure to identify which tables include records related to the record of the master table. The data structure, as more fully described below, may, for example, be a bitmap 311, an encoded vector index 312, or fields 313 within the master database table. Using this information, only those tables identified as having such records are accessed, in step 306, and appropriate actions taken, in step 308.

The data structure searched in step 304, therefore, reduces the number of I/O operations required to satisfy a referential integrity constraint. Embodiments of the present invention contemplate at least three different type of data structures that may be used to provide information about the records of the slave tables. It will be appreciated by those of ordinary skill in the art having the benefit of the instant disclosure that other data structures that are separate from the slave tables (or that otherwise do not require a slave table to be retrieved to satisfy a referential constraint determination) may be used in the alternative.

One such data structure includes a series of bitmaps. The basic idea behind a bitmap is to use a single bit (or some other relatively small amount of data) to indicate that a specific value of an attribute is associated with an entity. A bitmap may therefore also be considered to be a form of array, or vector. In one embodiment, each bit in a bitmap represents a mapping between a particular record in a master table and a particular slave table, where a value of 1 for the bit indicates that the particular slave table includes at least one record related to the particular record in the master table, and a value of 0 indicates that the particular slave table has no such related record.

The relative position of a bit within the bitmap can be mapped to the relevant record ID of the row in the table, and thus is said to be indexed by the record ID. In this embodiment, each column, or each vector, of the bitmap corresponds to one of the slave tables and each row of the bit map corresponds to a record in the master table. Thus, if the bit map value is “1” for a particular record of the master table and a particular slave table, then the database engine typically would determine that the referential integrity constraint requires accessing that slave table.

As is well known in the art, bitmaps are particularly attractive when the set of possible values for an index key is small. However, when a large number of values exist in an index, the size of a bitmap can become excessively large, and the data in the bitmap can become relatively sparse and inefficient. For example, in this context, where a large number of slave tables may exist, but few referential integrity constraints exist, the vast majority of a bitmap will be filled with “0” values.

Therefore, in some circumstances it may be desirable to use a form of bitmap referred to as an Encoded Vector Index (EVI) that retains much of the processing advantages of bit-mapped indexing and can also support larger tables with larger cardinalities with greater efficiency. An EVI typically consists of a Symbol Table and an Encoded Vector. The Symbol Table contains a sorted list of all the distinct values of a column in a table, a unique code assigned for each distinct value, and an occurrence count for each distinct value that indicates the number of rows in the table with that distinct value. The Encoded Vector is an array with a dimension equal to the number of rows in the table. Each entry or cell in the Encoded Vector contains the code from the Symbol Table that corresponds to the value contained in the row of the table. In one implementation described herein, an EVI may be defined with an Encoded Vector having an entry for each record of a master table, with the value in the entry for a particular record of the master table identifying which slave tables have corresponding records and thus need to be accessed.

An additional alternative to the above scheme is to include additional fields within the master database table itself. These fields may contain, for each record, a respective value that identify which slave tables have records corresponding to the record of the master table. Similar to a bitmap, the field, or fields, may contain single bits or like the EVI scheme, may contain a multi-bit value.

The database engine in accordance with the principles of the present invention advantageously includes functionality to update and maintain the data structures that store the referential integrity constraint information. The updating of the data structures may occur on an ongoing basis whenever a database instruction is performed. Accordingly, in addition to the various tables of the database being updated, the data structure is updated as well. Alternatively, the data structures may be periodically updated according to a fixed schedule. Following this alternative will result in certain tables being out of synchronization with the data structure once it is changed. Therefore, a flag or other indicator may be used to identify which values of the data structure are not up-to-date, and need to be updated prior to use.

Accordingly, a system and method has been described that uses a separate data structure to ensure that referential integrity constraints are satisfied between a master and slave tables. The data structure permits the constraints to be satisfied while avoiding unnecessary I/O operations involving slave tables with no records implicated by the constraint. Various modifications may be made to the illustrated embodiments without departing from the spirit and scope of the invention. Therefore, the invention lies in the claims hereinafter appended.

What is claimed is:

1. A method for providing a referential integrity constraint among a plurality of related tables comprising a master table and one or more slave tables, the method comprising:
identifying an action involving a record of the master table; and
determining from data separate from the one or more slave tables, which of the slave tables include at least one record related to the action.

2. The method of claim 1, wherein the action is a DELETE instruction.

3. The method of claim 2, wherein the referential integrity constraint results in a cascading DELETE among the one or more slave tables.

4. The method of claim 1, further comprising the steps of:
performing one or more I/O operations on the slave tables determined to include at least one record related to the action; and
avoiding any I/O operations involving slave tables determined to not include at least one record related to the action.

5. The method of claim 1, wherein the data includes one of a bitmap, an encoded vector index; and one or more fields of a record in the master table.

6. The method of claim 1, wherein the data includes a bitmap, the bitmap including a respective column for each of the plurality of slave tables, wherein each row of each column defines an entry corresponding to a record within the master table, and a first value of the entry indicates the respective slave table includes a record associated with the record within the master table and a second value of the entry indicates the respective slave table does not include a record associated with the record within the master table.

7. The method of claim 6, wherein each entry in the bitmap comprises a single bit.

8. The method of claim 1, wherein the data includes an encoded vector index, the encoded vector index including a column of entries, each row of the column corresponding to a record of the master table, and a value of each entry in the column identifying which slave tables include at least one record associated with the respective record of the master table.

9. The method of claim 1, wherein the data includes at least one field in each record in the master table, the at least one field including a value identifying which slave tables include at least one record associated with that record of the master table.

10. An apparatus comprising:
a database including a master table and at least one slave table linked to the master table through a constraint; and
a data structure storing referential integrity constraint information related to the constraint between records of the master table and the at least one slave table.

11. The apparatus of claim 9, wherein the data structure includes one of a bitmap scheme, an encoded vector index; and one or more fields of a record in the master table.

12. The apparatus of claim 10, wherein the data structure includes a bitmap, the bitmap including a column the slave table and at least one additional slave table, wherein each row of each column defines an entry corresponding to a record within the master table, and a first value of the entry indicates the respective slave table includes a record associated with the record within the master table and a second value of the entry indicates the respective slave table does not include a record associated with the record within the master table.

13. The method of claim 12, wherein each entry in the bitmap comprises a single bit.

14. The apparatus of claim 10, wherein the data structure includes an encoded vector index, the encoded vector index including a column of entries, each row of the column corresponding to a record of the master table, and a value of each entry in the column identifying whether the slave table includes at least one record associated with the respective record of the master table.

15. The apparatus of claim 10, wherein the data structure includes at least one field in each record in the master table, the at least one field including a value identifying whether the slave table includes at least one record associated with that record of the master table.

16. The apparatus of claim 10, wherein the data structure is separate from the slave table such that the referential integrity constraint information can be accessed without accessing the slave table.

17. The apparatus of claim 10, further comprising:
at least one processor;
a memory coupled with the at least one processor; and
program code residing in the memory and executed by the at least one processor, the program code configured to determine from the data structure if the slave table includes at least one record related to the action.

18. The apparatus of claim 17, wherein the program code is further configured to perform one or more I/O operations on the slave table if the slave table is determined from the data structure to include at least one record related to the action, and to avoid any I/O operations involving the slave table if the slave table is determined from the data structure to not include at least one record related to the action.

19. An apparatus comprising:
at least one processor;
a memory coupled with the at least one processor and storing a plurality of related tables comprising a master table and one or more slave tables; and
program code residing in the memory and executed by the at least one processor, the program code configured to identify an action involving a record of the master table, and determine from data separate from the one or more slave tables, which of the slave tables includes at least one record related to the action.

20. A program product comprising:
program code configured upon execution to:
identify an action involving a record of a master table in a database having constraints defined that involve one or more slave tables; and
determine from data separate from the one or more slave tables, which of the slave tables include at least one record related to the action; and a computer readable signal bearing medium bearing the program code.
